(19) United States
(12) Patent Application Publication
(10) Pub. No.: US 2014/0104048 A1
(43) Pub. Date: Apr. 17, 2014

(54) ANTI-THEFT SYSTEM FOR AN AUTOMOTIVE EXHAUST COMPONENT

(71) Applicants: Filip De Kock, Canford Cliffs (GB); Clive Finnis, Christchurch (GB)

(72) Inventors: Filip De Kock, Canford Cliffs (GB); Clive Finnis, Christchurch (GB)

(21) Appl. No.: 14/119,163

(22) PCT Filed: May 25, 2012
(86) PCT No.: PCT/GB2012/051197

§ 371 Date: Nov. 20, 2013

(30) Foreign Application Priority Data
May 27, 2011 (GB) 1109007.3

(51) Int. Cl. G08B 13/16

(52) U.S. Cl. CPC G08B 13/1654
USPC 340/429

(57) ABSTRACT

An anti-theft system for protecting a vehicle exhaust component (4) is described. The system includes a sensor (1) configured to monitor vibrations associated with a vehicle exhaust system (5)and a controller (2) arranged to monitor a signal from the sensor (1). The controller (2) is configured to generate an alarm event if the signal from the sensor includes characteristics indicative of vibrations associated with an attempted theft of the vehicle exhaust component (4).

### TECHNICAL FIELD

The present invention relates to an anti-theft system, device and method for protecting vehicle exhaust components, in particular catalytic converters and/or particulate filters.

### BACKGROUND

The system is designed to prevent the theft of catalytic converters or particulate filters from vehicles. These items are stolen and sold for scrap as they contain precious metals such as platinum and palladium. The replacement cost of these items is considerable, particularly for lorries and large commercial vehicles, and could reach £10,000 per unit.

### SUMMARY OF THE INVENTION

According to a first aspect of the present invention there is provided an anti-theft system for protecting a vehicle exhaust component, the system comprising:
a sensor configured to monitor vibrations associated with a vehicle exhaust system; and
a controller arranged to monitor a signal from the sensor;
   wherein the controller is configured to generate an alarm event if the signal from the sensor includes characteristics indicative of vibrations associated with an attempted theft of the vehicle exhaust component.

The vehicle exhaust component is preferably a catalytic converter and/or a particulate filter.

The system may further comprise a siren in communication with the controller, and the alarm event may comprise triggering the siren.

The system may include a communications module, for example a GSM module. The alarm event may comprise generating a text alert (e.g. an SMS message) or initiating a telephone call to a predefined telephone number to report an attempted theft in progress. The communications module may be part of the controller or connected to the controller.

Typically, theft of a catalytic converter or particulate filter involves use of a saw or other cutting implement to shear through the exhaust pipe. The controller is preferably configured to detect characteristics in the sensor signal indicative of vibrations associated with the use of a cutting implement acting against the exhaust pipe, for example a hacksaw, electric saw, grinder or pipe cutter.

The controller is preferably configured to distinguish between ‘normal’ vibrations and vibrations that are characteristic of an attempted theft. In this regard, the controller may be configured to recognise ‘normal’ vibrations such as those characteristic of the loading and unloading of the vehicle. The controller may be programmed to filter these ‘normal’ characteristics from the sensor signal.

The sensor may be configured to detect sounds that are characteristic of an attempted theft of the exhaust component. For example, sounds that are characteristic of the use of cutting implements such as a hacksaw, electric saw, grinder, pipe cutter or other such implement. The controller may be programmed to recognise such sounds in the sensor signal and generate the alarm event if such a sound is detected.

The controller may be suitably programmed to trigger an alarm event if a sound characteristic of an attempted theft is detected and/or if vibrations associated with the fuel system are indicative of a theft attempt. In variants of the invention, separate sensors may be employed to detect vibrations and sounds independently. For example, a suitable transducer such as a microphone or another suitable sampling device may be used to detect sounds. Embodiments of the invention are envisaged in which only sound is monitored and not vibrations.

The sensor may be suitably ‘tuned’ to detect vibrations that are characteristic of an attempted theft of the vehicle component. In this regard the sensor may be configured to generate a relatively weak output signal in response to ‘normal’ vibrations and a relatively strong output signal in response to vibrations characteristic of an attempted theft of the vehicle component. The controller may be configured to generate the alarm event when the intensity of the signal from the sensor exceeds a predefined threshold, which is indicative of a theft attempt.

The sensor is preferably configured to output a ‘heartbeat’ signal to the controller. The ‘heartbeat’ signal preferably comprises a pulsed signal that is sent continuously to the controller. If any attempt is made to tamper with the system, for example if the wire is cut between the sensor and the controller, the heartbeat signal would be interrupted. The controller is preferably configured to generate an alarm event in the absence of the heartbeat signal or if the heartbeat signal is interrupted.

The sensor may be a piezoelectric sensor, or any other sensor capable of monitoring vibrations. However, the sensor is preferably a solid state device, for example a silicon chip semiconductor device. A solid state device may advantageously be encapsulated in waterproof material (for example ‘potting compound’) so that the device is impervious to water ingress even when subjected to high pressure jet washers, which are commonly used for cleaning and maintenance of heavy goods vehicles and the like.

The sensor is preferably unidirectional so that it can be mounted in any orientation without loss of performance. The sensor is optionally arranged to detect vibrations in three spatial dimensions.

The sensor is preferably arranged to detect vibrations at least in the frequency range 100 Hz to 1,500 Hz. Many other vibration sensors only respond to very high frequencies typically above 15 kHz and are therefore not well suited for the detection of relatively low frequencies, which have been identified as being characteristic of cutting tools acting upon vehicle exhaust components, such as an exhaust pipe or a catalytic converter.

The system is optionally adapted to discount (i.e. ignore) vibrations having frequencies outside a predetermined frequency range, preferably between about 100 Hz and 1,500 Hz. The system is optionally adapted to discount vibrations having an amplitude below a predefined minimum amplitude. The system is optionally adapted to determine a threat duration (i.e. a time period for which vibrations characteristic of an attempted theft persist) and to use the threat duration to determine whether to generate an alarm event (such as to switch on an alarm siren and/or a flashing beacon). For example, the system may be configured to generate an alarm event only when vibrations characteristic of an attempted theft persist for at least a predetermined time period.

The sensor is preferably coupled to an exhaust pipe of the vehicle exhaust system.

The system may comprise additional sensors in communication with the controller. For example, an additional movement or positional sensor may be associated with the sensor to detect any unauthorised attempt to remove the sensor from the exhaust system.

The system may also be configured to protect the fuel system of the vehicle. In this regard, the system may comprise additional sensors associated with the fuel system. Such additional sensors may include a sensor associated with the fuel cap for detecting tampering associated with the fuel cap; fuel level sensors within the fuel tank; and/or sensors configured to detect tampering with the fuel tank. These sensors may be connected to the controller, which is configured to monitor the output signals from these sensors and generate an alarm event if an unauthorised attempt is made to remove fuel from the vehicle. For example, the system may be configured to generate an alarm event if the fuel level sensor detects a rapid loss of fuel, or any significant loss of fuel when the engine is turned off.

The system may also be configured to detect attempted theft of other valuable vehicle components, for example the wheels. In this regard, the system may further comprise a wheel sensor for monitoring vibrations associated with a wheel of the vehicle, the controller being configured to monitor signals from the wheel sensor, and the system being configured to generate an alarm event if the signal from the wheel sensor includes characteristics indicative of vibrations associated with an attempted theft of the wheel.

According to a second aspect of the present invention there is provided an anti-theft device for protecting a vehicle exhaust component, the device comprising:
a sensor unit for a vehicle exhaust pipe; and
a control unit arranged to monitor a signal from the sensor unit and generate an alarm event if the signal from the sensor unit includes characteristics indicative of vibrations associated with an attempted theft of the vehicle exhaust component.

The sensor unit is preferably adapted to be mounted on the vehicle exhaust pipe. In this respect the sensor unit may comprise a suitable bracket to facilitate mounting to the exhaust pipe. The sensor unit is preferably thermally insulated from the bracket to protect the sensor. Vibration damping means are preferably provided between the sensor unit and the bracket to protect the sensor unit from mechanical vibrations during use of the vehicle. To this end, damping means may be provided between the sensor unit and the bracket. Rubber damping means conveniently provide vibration damping and temperature isolation. The bracket may comprise two parts or plates. A lower plate may be coupled to the exhaust pipe. An upper plate may be coupled to the lower plate. The sensor unit may be coupled to the upper plate. Damping/thermal isolation means may be provided between the upper and lower plate to thermally insulate the sensor unit from the exhaust pipe and to dampen vibrations associated with normal vehicle use to protect the sensor unit. Alternatively the sensor unit may be encapsulated in a rubber type of compound which is bonded to the lower plate. This rubber type of compound fulfils the requirements of providing damping/thermal isolation as described above and also is impervious to water ingress.

The system preferably also comprises a suitable siren and/or a communications module for generating a text or telephone alert in the event of a theft.

The control unit preferably includes a sealed housing. The housing is preferably filled with a gel, which sets to become a solid resin. The solid resin encases the electronic components within the housing. In addition to providing physical protection for the components, this makes reverse engineering of the control hardware and software more difficult. Alternatively the control unit may be encapsulated in a rubber type of compound which fulfils the requirements of providing physical protection for the components and makes reverse engineering of the control hardware and software more difficult.

The optional features described above in relation to the first aspect of the present invention apply equally to the second aspect of the present invention, and so are not repeated herein.

According to a third aspect of the present invention there is provided a method of detecting the attempted theft of a vehicle exhaust component, the method comprising:
monitoring vibrations associated with a vehicle exhaust system; and
generating an alarm event if the vibrations are characteristic of an attempted theft of the vehicle exhaust component.

Preferably the method comprises distinguishing between ‘normal’ vibrations (as described above) and vibrations indicative of an attempted theft, for example vibrations characteristic of the use of a saw against the vehicle exhaust pipe.

Preferably, the method includes determining whether the vibrations are characteristic of an attempted theft of the vehicle exhaust component on the basis of whether the frequency of the vibrations lie within a predetermined frequency range.

Preferably, the method includes determining whether the vibrations are characteristic of an attempted theft of the vehicle exhaust component on the basis of whether the amplitude of the vibrations lie within a predetermined amplitude range.

The method may include activating the alarm event only if the vibrations persist for more than a predetermined time period.

Other optional features described in relation to the first aspect of the present invention apply equally to the third aspect of the present invention and so are not repeated herein.

It will be appreciated that the anti-theft devices or systems described above may be aftermarket or original equipment manufacturer (OEM) devices. The device may be separate from the OEM vehicle alarm system, for example using a separate control unit, siren etc, or it may be integrated with the OEM alarm system such that, for example, the sensors communicate with the main vehicle alarm control system and utilise the main vehicle alarm siren.

Expressed in other terms, the present invention provides an anti-theft system for protecting a vehicle exhaust component, the system comprising:
a sensor configured to detect sound and/or vibrations; and
a controller arranged to monitor a signal from the sensor; wherein the controller is configured to generate an alarm event if the signal from the sensor includes characteristic features indicative of an attempted theft of the vehicle exhaust component.

The characteristic features may be sounds or vibrations that are associated with an attempted theft of the vehicle exhaust component, or a tampering event. For example, the sound may be the sound associated with a cutting implement such as a hacksaw, electric saw, grinder, pipe cutter etc acting on the exhaust pipe, or a vibration in the exhaust system caused by such implements. These characteristic features may be uniquely associated with the use of such implements, and in this respect, the features constitute a ‘signature’ in the sensor signal indicative of a theft attempt or other such tampering event.

When expressed in these terms, the present invention also provides an anti-theft device for protecting a vehicle exhaust component, the device comprising:
a sensor unit for a vehicle exhaust pipe, the sensor unit being configured to monitor sounds and/or vibrations; and
a control unit arranged to monitor a signal from the sensor unit and generate an alarm event if the signal from the sensor unit includes sound or vibration features that are characteristic of an attempted theft of the vehicle exhaust component.

Further, when expressed in these terms, the present invention also provides a method of detecting the attempted theft of a vehicle exhaust component, the method comprising:
monitoring sounds and/or vibrations; and
generating an alarm event if the sounds and/or vibrations are characteristic of an attempted theft of the vehicle exhaust component.

Preferably the method involves monitoring an output signal from the sensor and generating an alarm event if the signal includes features characteristic of a theft attempt or tampering event associated with the exhaust component. Preferably the sounds and/or vibrations are uniquely characteristic of an attempted theft of the vehicle exhaust component. Preferably the method comprises monitoring the sounds and/or vibrations using a sensor unit coupled to the vehicle exhaust system, preferably to the exhaust pipe.

It should be appreciated that optional features described in relation to any particular aspect of the invention apply equally to the other aspects of the invention and to the invention when expressed in the terms described immediately above, and vice versa.

The inventive concept encompasses an exhaust pipe for a vehicle, the exhaust pipe having an anti theft device as described above associated therewith.

The inventive concept also encompasses a vehicle having an anti theft device or an anti theft system described above. The vehicle is preferably an automobile such as a car or truck. The system is particularly suitable for trucks, which tend to have high-value catalytic converters and particulate filters, and which generally carry a high fuel load.

### BRIEF DESCRIPTION OF THE DRAWINGS

In order that the invention may be more readily understood, reference will now be made, by way of example only, to the following figures in which:

FIG. 1 is a schematic diagram showing an anti-theft system in accordance with a first embodiment of the present invention;

FIG. 1A is a schematic diagram showing a heartbeat signal in accordance with the present invention;

FIG. 2 is an enlarged view of part of FIG. 1, showing a sensor unit of the anti-theft system mounted to an exhaust pipe using a bracket;

FIG. 3 is a circuit diagram of a sensor chip of the sensor unit of FIG. 2;

FIGS. 4 to 11A are a series of graphs and schematic diagrams showing the results of experiments using an audio microphone to measure the vibrations of steel exhaust pipes either alone or in combination with a catalytic converter, in response to various external stimuli, wherein:

FIG. 4 is a graph showing vibrations due only to background noise in the laboratory;

FIG. 5 is a graph showing the vibrations of a 32 mm diameter steel pipe when tapped using a metal rod;

FIG. 6 is a graph showing the vibrations of the 32 mm diameter pipe when cut with a hacksaw;

FIG. 7 is a graph showing the vibrations of an assembly comprising a catalytic converter connected between first and second sections of 48 mm diameter steel pipe when the first section of pipe is tapped using a metal rod as shown in FIG. 7A;

FIG. 7A is a schematic diagram showing the experimental set-up used to produce the results of FIG. 7;

FIG. 8 is a graph showing the measured vibrations when the second section of pipe of the assembly is tapped using the metal rod, as shown in FIG. 8A;

FIG. 9 is a graph showing the measured vibrations when the catalytic converter of the assembly is tapped using the metal rod, as shown in FIG. 9A;

FIG. 10 is a graph showing the measured vibrations when a hacksaw is used to cut through the first section of pipe of the assembly, as shown in FIG. 10A;

FIG. 11 is a graph showing the measured vibrations when a manual rotary pipe cutter is used to cut through the first section of pipe of the assembly, as shown in FIG. 11A; and

FIGS. 12 to 17A are a series of graphs and schematic diagrams showing the results of experiments using an ultrasonic microphone to measure the vibrations of a steel exhaust pipe either alone or in combination with a catalytic converter in response to various external stimuli, wherein:

FIG. 12 is a graph showing vibrations due only to background noise in the laboratory;

FIG. 13 is a graph showing the measured vibrations of an assembly comprising a catalytic converter connected between first and second sections of 48 mm diameter steel pipe when the first section of pipe is tapped using a metal rod as shown in FIG. 13A;

FIG. 13A is a schematic diagram showing the experimental set-up used to produce the results of FIG. 13;

FIG. 14 is a graph showing the measured vibrations when the second section of pipe is tapped using a metal rod as shown in FIG. 14A;

FIG. 15 is a graph showing the measured vibrations when the catalytic converter of the assembly is tapped using a metal rod as shown in FIG. 15A;

FIG. 16 is a graph showing the measured vibrations when a hacksaw is used to cut through the first section of pipe of the assembly, as shown in FIG. 16A;

FIG. 17 is a graph showing the measured vibrations when a manual rotary pipe cutter is used to cut through the first section of pipe of the assembly, as shown in FIG. 17A; and

FIG. 18 is a block diagram showing aspects of the processing arrangement of the sensor unit 15 and the controller 16 of FIG. 2.

### DETAILED DESCRIPTION

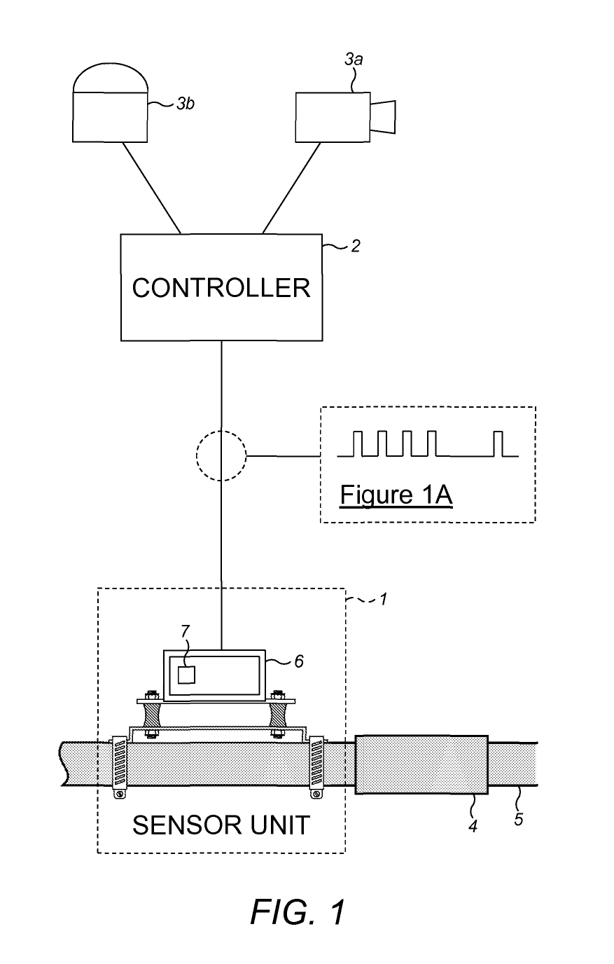

Referring to FIG. 1, the system comprises a sensor unit 1, a control unit (also referred to as a controller) 2, and an alarm siren 3a. The system also optionally comprises a beacon 3b, which is arranged to flash if the alarm is activated. The sensor unit 1 further comprises a box or housing 6.

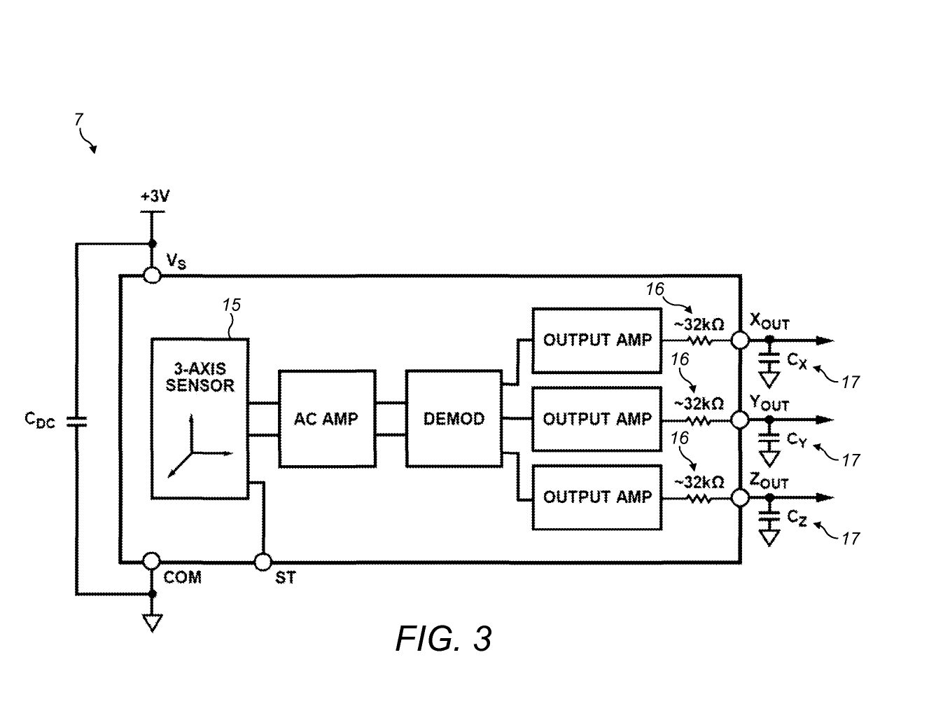

The sensor unit 1 contains a vibration sensor comprising a sensor chip 7 and various circuits for analysing and processing the output of the sensor chip 7. The sensor chip 7 comprises an accelerometer 15 (as shown in FIG. 3). The sensor unit 1 is mounted on the catalytic converter/particulate filter 4 or nearby on the exhaust pipe 5. Housing 6 is sealed against ingress of high-pressure water, as it is common to use water jets to clean the underside of commercial vehicles.

The sensor unit 1 is mounted in such a way as to minimise heat transfer from the vehicle exhaust system to the sensor unit 1 to prevent damage to the sensor chip 7 mounted inside the housing 6.

The accelerometer 15 (FIG. 3) is tuned to the typical vibration frequencies of hacksaws or electric saws used illegally to remove catalytic converters, particulate filters and other exhaust components. The sensor unit 1 may comprise additional internal positional/motion sensors arranged to detect any attempt to remove the sensor unit 1.

The control unit 2 comprises a box that is mounted under the vehicle bonnet or cab or other relatively secure area so that it can only be accessed by bypassing the vehicle manufacturer's fitted alarm system. The control unit 2 is connected to the sensor unit 1 by three wires. Cutting any one of these wires will sound the alarm siren 3a.

The control unit 2 also contains an internal rechargeable battery backup and thus can continue to function should the vehicle's own batteries be tampered with. As a result, a beneficial by-product of this approach is that the system inherently acts as a battery theft protection unit as it will sound the alarm 3a should it detect that the vehicle battery supply has been cut.

The system is arranged to be inactive when vehicle ignition is on in order to meet Government VCA approval. The system is arranged to become ‘active’ automatically after a predefined time period (typically a few minutes) when the vehicle ignition has been turned off, i.e. when the vehicle is parked. The system is arranged such that the alarm 3a cannot sound when the ignition is on and the vehicle is in motion. The system can be turned off to enable standard vehicle maintenance/servicing or the replacement/repair of the exhaust system without generating an alarm event.

The software in the control unit 2 is arranged to ignore the bumps and vibrations of a commercial vehicle being loaded or unloaded during normal use, and will only react to the specific vibration frequencies associated with the use of saws and other cutting implements used to remove the catalytic converter/particulate filter. Thus, the system is arranged to prevent false alarms.

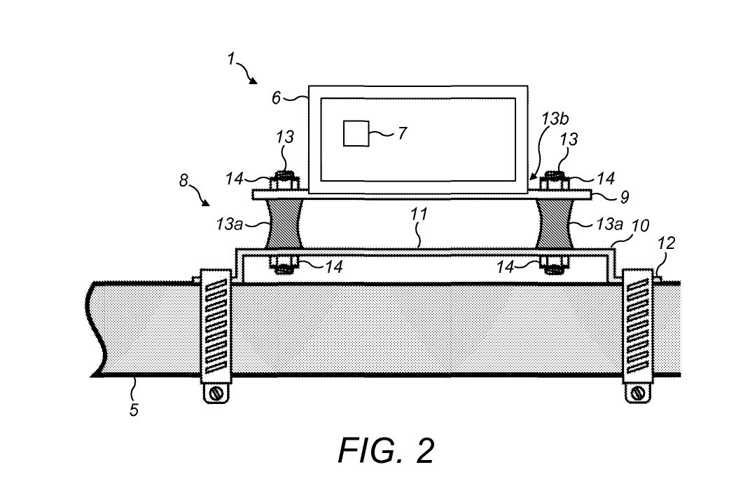

Referring to FIG. 2, this shows a bracket 8 for mounting the sensor unit 1 to an exhaust pipe 5 of the vehicle. The bracket 8 includes upper and lower plates 9, 10. The lower plate 10 has a central portion 11 and peripheral flanges 12. The peripheral flanges 12 abut the exhaust pipe 5 whilst the central portion 11 is spaced-apart from the exhaust pipe 5. This arrangement serves to minimise the surface area of the bracket 8 that is in direct contact with the exhaust pipe 5. The upper plate 9 is substantially flat and is coupled to the lower plate 10 via a pair of bolts 13 extending through holes in the upper plate 9 and holes provided in the central portion 11 of the lower plate 10. The bolts 13 are secured with suitable nuts 14. The sensor unit 1 is mounted to the upper plate 9 using four suitable fasteners. Rubber blocks 13a are provided between the upper and lower plates 9, 10 and a rubber pad 13b is provided between the housing 6 of the sensor unit 1 and the upper plate 9. These serve to thermally insulate the sensor unit 1 from the hot exhaust pipe 5 and also to provide damping of vibrations associated with normal use of the vehicle, thereby protecting the sensor unit 1.

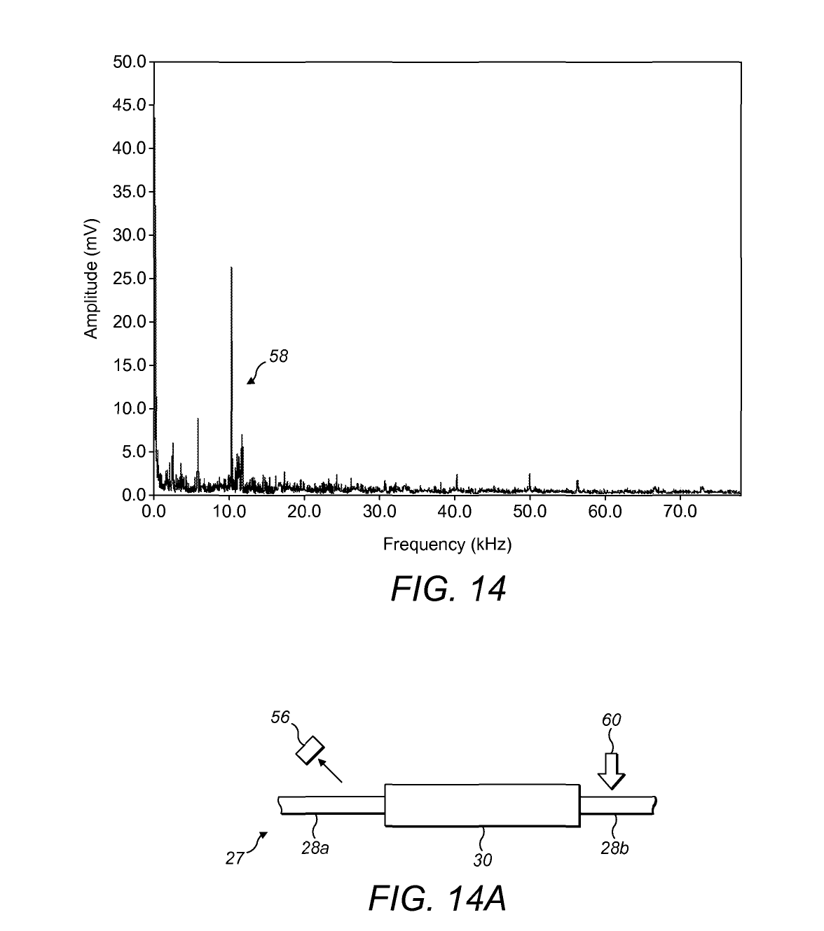

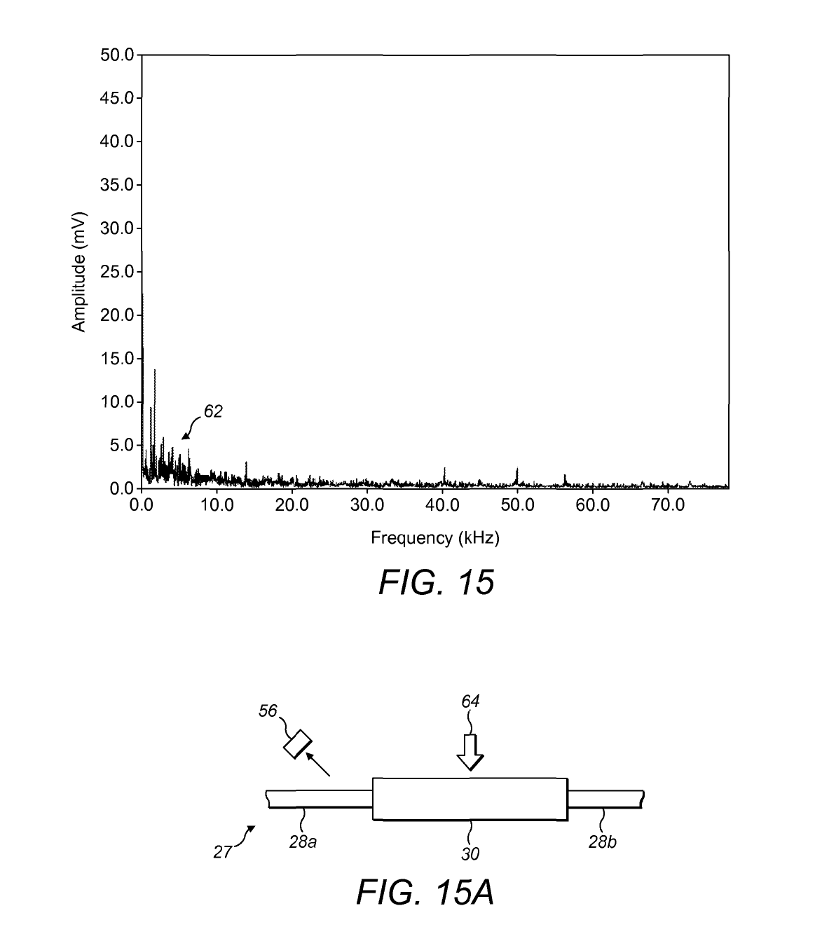

Further details of the sensor unit 1 and its operation will now be described with reference to FIGS. 3 to 18.

Referring to FIG. 3, the sensor unit 1 comprises a sensor chip 7 comprising a small, low power, complete 3-axis accelerometer 15 with signal conditioned voltage outputs. The accelerometer 15 measures acceleration with a minimum full-scale range of ±2 g (where g is acceleration due to gravity, which is approximately 9.81 ms⁻²). The accelerometer 15 can measure the static acceleration of gravity in tilt-sensing applications, as well as dynamic acceleration, resulting from motion, shock, or vibration.

In addition to the polysilicon surface micromachined accelerometer 15, the sensor chip 7 also comprises signal conditioning circuitry to implement an open-loop acceleration measurement architecture. The resulting output signals are analog voltages that are proportional to acceleration.

The accelerometer 15 is built on top of a silicon wafer. Polysilicon springs suspend the accelerometer 15 over the surface of the wafer and provide a resistance against acceleration forces. Deflection of the accelerometer 15 is measured using a differential capacitor that consists of independent fixed plates and plates attached to a moving mass. The fixed plates are driven by 180° out-of-phase square waves. Acceleration deflects the moving mass and unbalances the differential capacitor resulting in a sensor output whose amplitude is proportional to acceleration. Phase-sensitive demodulation techniques are then used to determine the magnitude and direction of the acceleration.

The bandwidth of the accelerometer 15 is set using the CX, CY, and CZ capacitors 17 at the XOUT, YOUT, and ZOUT pins. Bandwidth is selected to suit the application of the invention with a range of 100 Hz to 1500 Hz for X and Y axes and a range of 100 Hz to 550 Hz for the Z axis.

The demodulator output is amplified and brought off-chip through a 32 kΩ resistor 16 and the signal bandwidth of the device is set by adding external capacitive filters. This filtering improves measurement resolution and helps prevent aliasing.

Further features of the accelerometer 15 include: low power, typically 350 μA; single-supply operation of 1.8 V to 3.6 V; 10,000 g shock survival; excellent temperature stability; bandwidth adjustment with a single capacitor per axis.

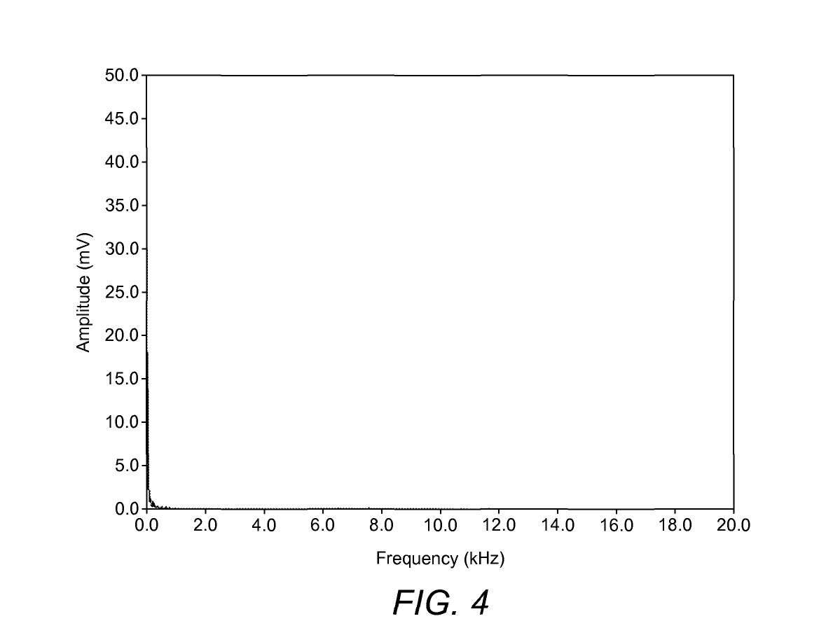

When various tools are used to cut an exhaust pipe 5 in an attempt to steal a catalytic converter, each tool is associated with “signatory” response vibrations of the exhaust pipe 5 and catalytic converter 4. Various examples are shown in the experimental results of FIGS. 4 to 17A, and are described as follows.

FIG. 4 shows the background noise level in the laboratory to give a reference level. As in all the following graphs the X axis (horizontal axis) is in ascending frequency in kHz and the Y axis (vertical axis) is in ascending voltage amplitude in mV. As can be seen there is no significant background noise to distort the readings displayed in the subsequent graphs.

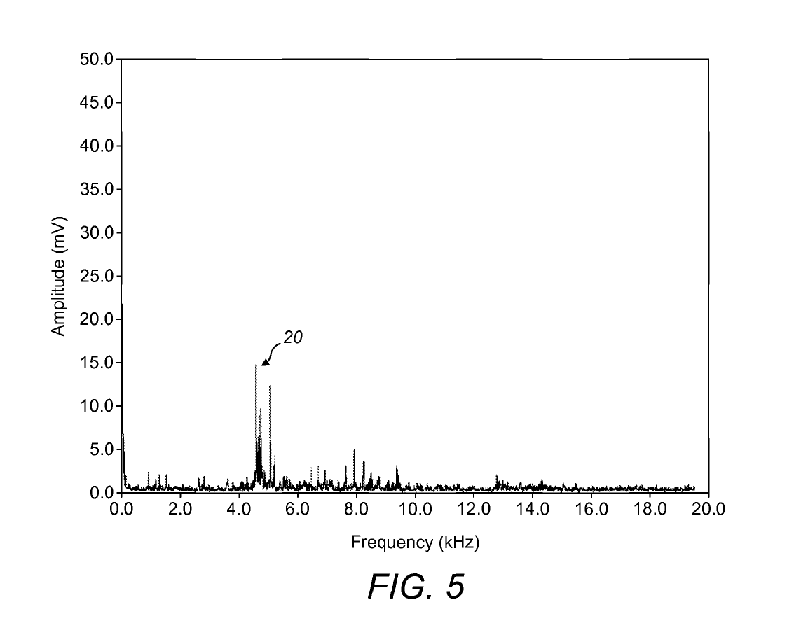

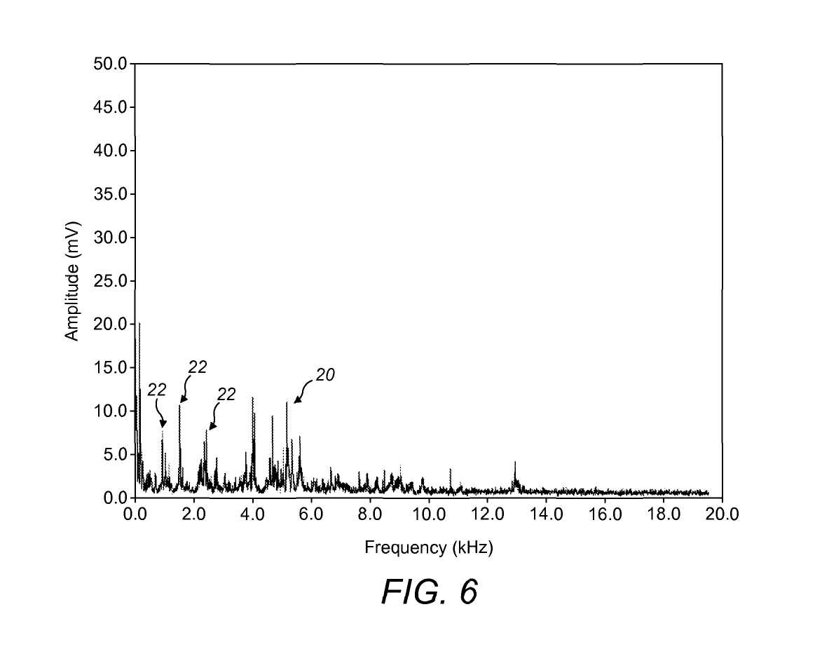

FIG. 5 shows the natural resonant frequency 20 of a 32 mm diameter steel pipe when tapped with a metal rod. FIG. 6 shows the effect of manually cutting this pipe with a hacksaw. Ignoring the pipe's natural resonances 20 around 4.0 to 5.5 kHz, it can clearly be seen that characteristic frequencies 22 produced by the hacksaw are below about 2.5 kHz. There is also a lack of any discernable frequencies other than background noise above about 13 kHz.

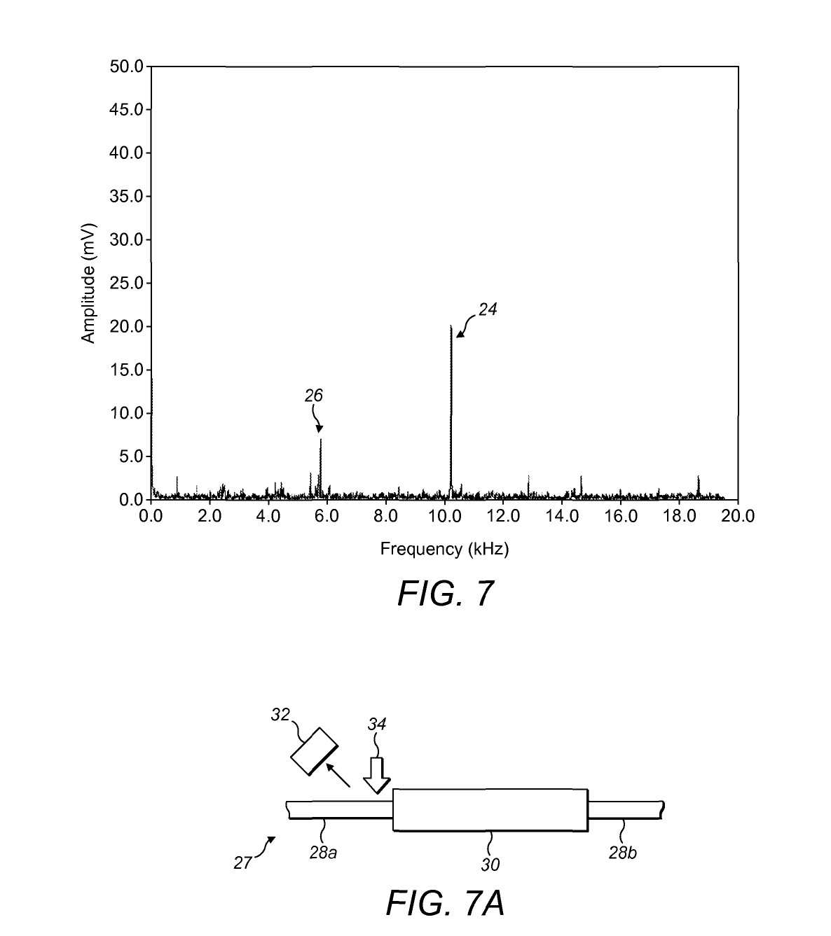

FIG. 7A shows an assembly 27 comprising a catalytic converter 30 connected between first and second sections of steel pipe 28a, 28b, each section of pipe having a diameter of 48 mm. An audio microphone 32 is positioned adjacent the first section of pipe 28a. The first section of pipe 28a is tapped using a metal rod as represented by the arrow 34, and the frequency resonance of the assembly 27 is shown in FIG. 7. Referring to FIG. 7, when the assembly 27 is tapped in this way, the prime resonant frequency 24 of the assembly 27 is approximately 10.5 kHz and there is a sub-harmonic frequency 26 of approximately 5.75 kHz.

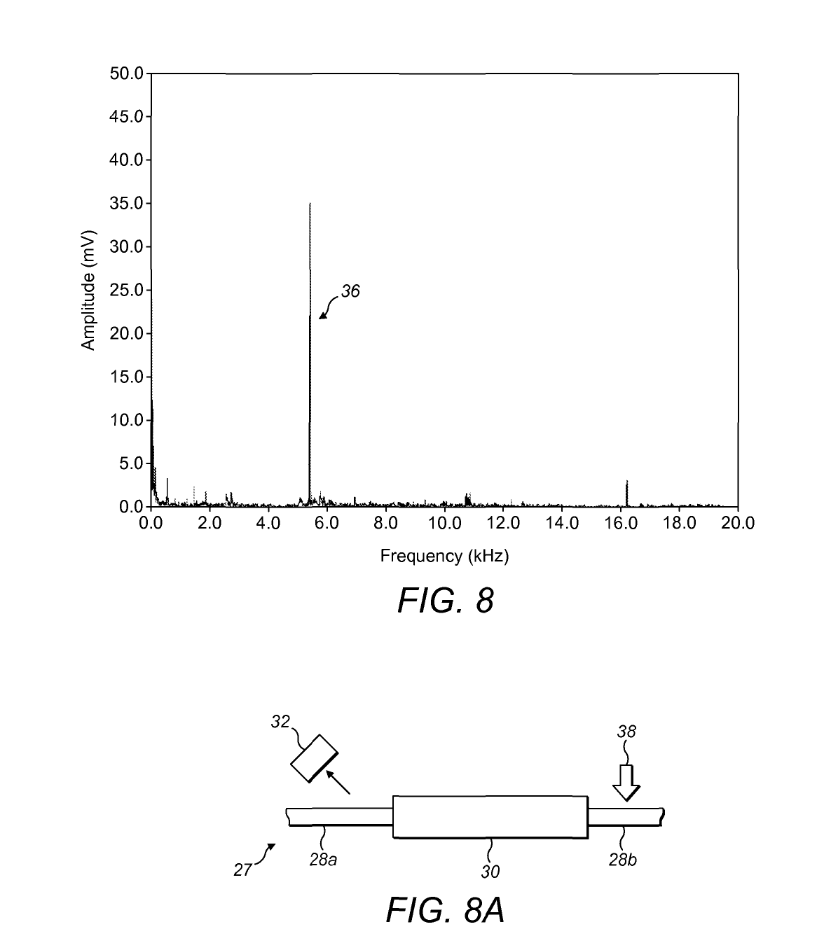

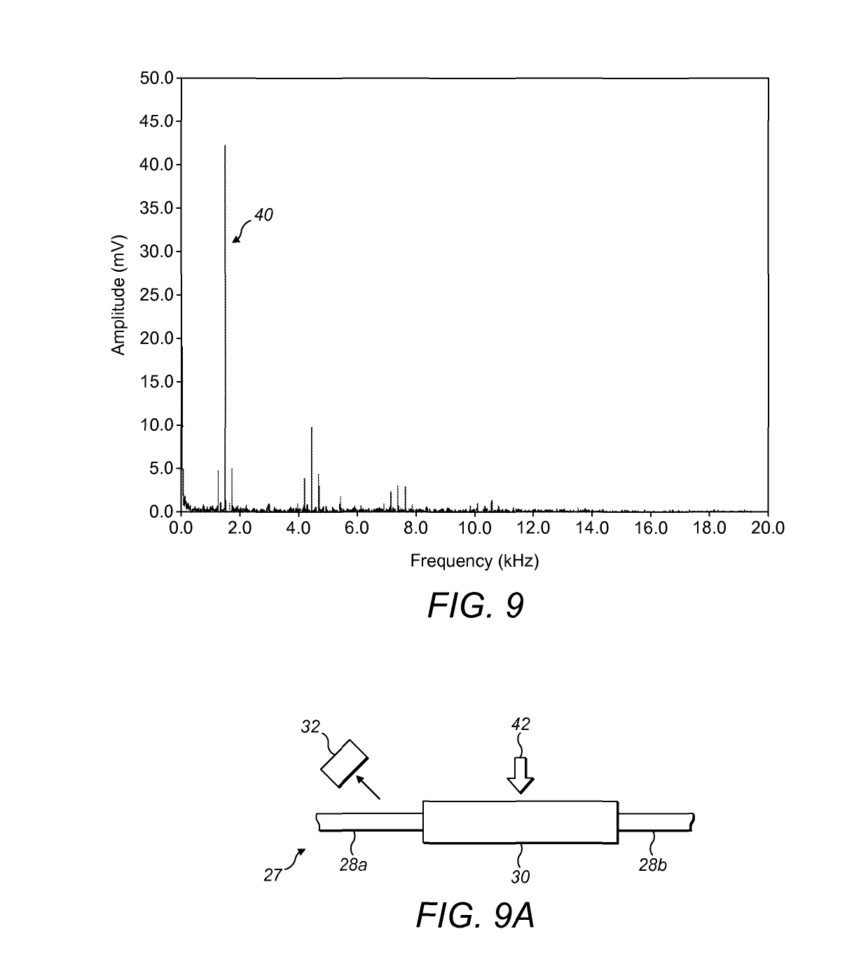

FIGS. 8, 8A, 9 and 9A show the frequency resonances of the assembly 27 when tapped at various points with the metal rod. In FIG. 8 the dominant frequency 36 of approximately 5.75 kHz is produced by tapping the second section of pipe 28b as represented by arrow 38 in FIG. 8A. In FIG. 9 the resonant frequency 40 of approximately 1.5 kHz is produced by tapping the catalytic converter 30, as represented by arrow 42 in FIG. 9A. The frequency peak 40 is the catalytic converter's own resonant frequency.

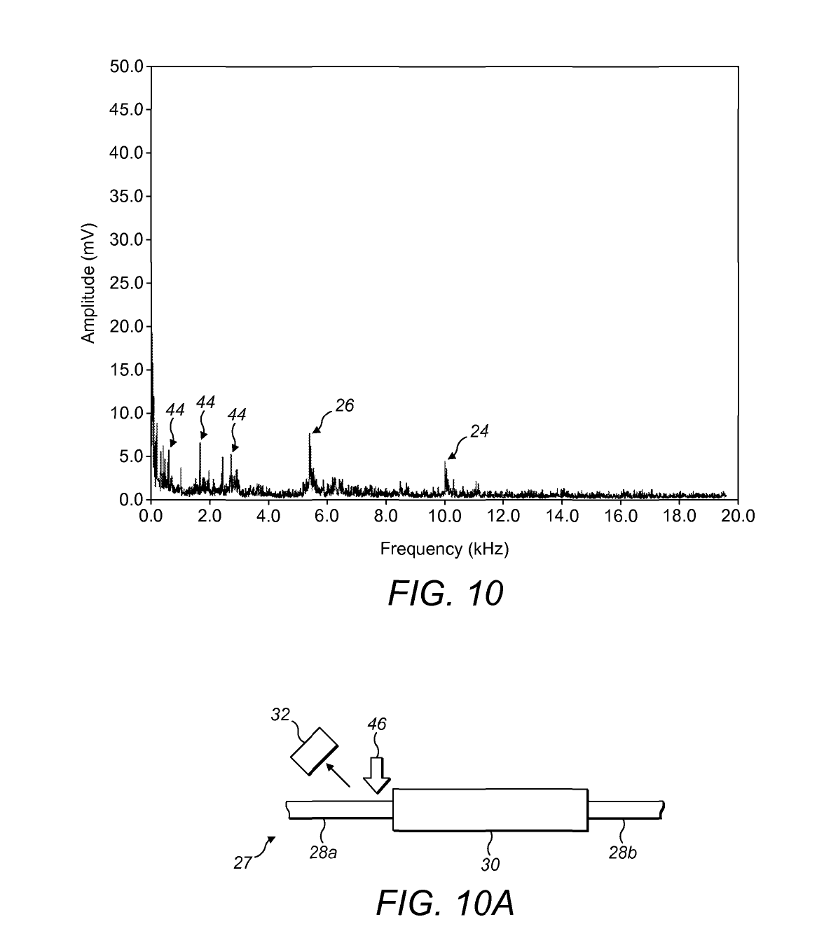

FIG. 10 shows the effect of manually hacksawing the first section of steel pipe 28a, as represented by the arrow 46 in FIG. 10A. Again, it can clearly be seen that characteristic frequencies 44 produced by the hacksaw are below 2.5 kHz, and that the assembly 27 has resonant frequencies 24 and 26 in the range of about 5.75 kHz to about 10 kHz. Also, there are no discernable frequencies other than background noise above about 10 kHz.

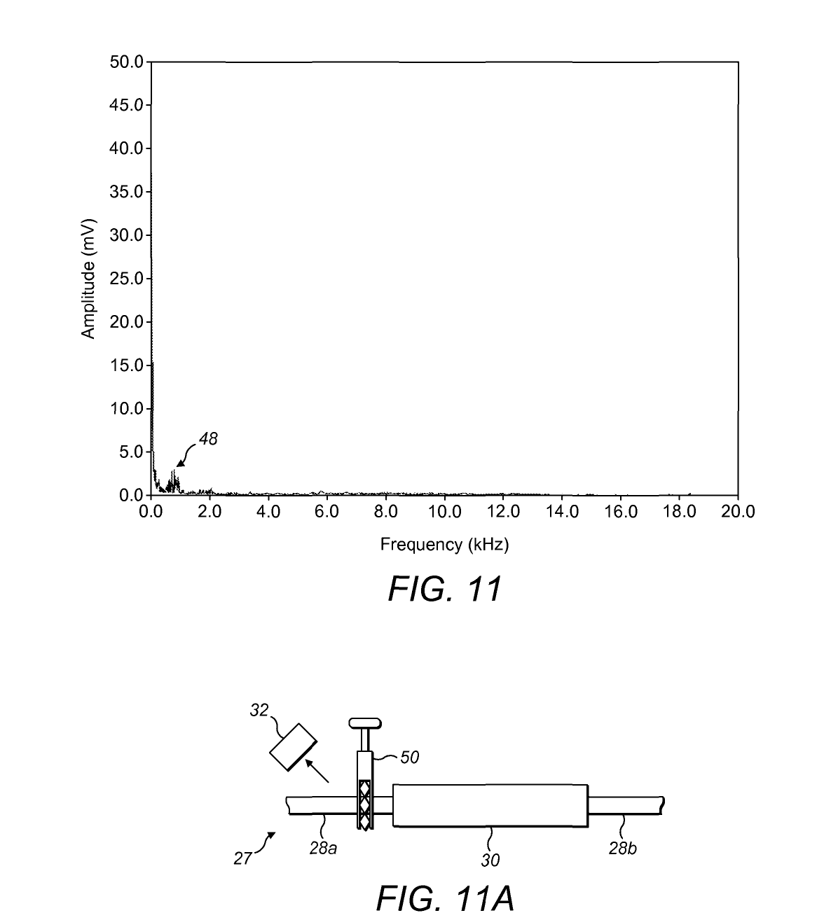

FIG. 11 shows the vibrational response of the assembly 27 when the first section of pipe 28a is cut using a manual rotary pipe cutter 50, as shown in FIG. 11A. In this case it can clearly be seen that characteristic frequencies 48 produced by this implement are of low amplitude and a very low frequency, below about 1 kHz. There are no discernable high frequencies other than background noise.

The experiments shown in FIGS. 4 to 11A were performed with an audio band microphone 32 whose frequency response diminished above 20 kHz. Thus, if ultra-sonic frequencies were present it is possible that this microphone 32 did not detect them. To account for this potential shortfall in the experimental data, the experiments were repeated with a high frequency microphone 56 which was capable of detecting frequencies upto 100 kHz.

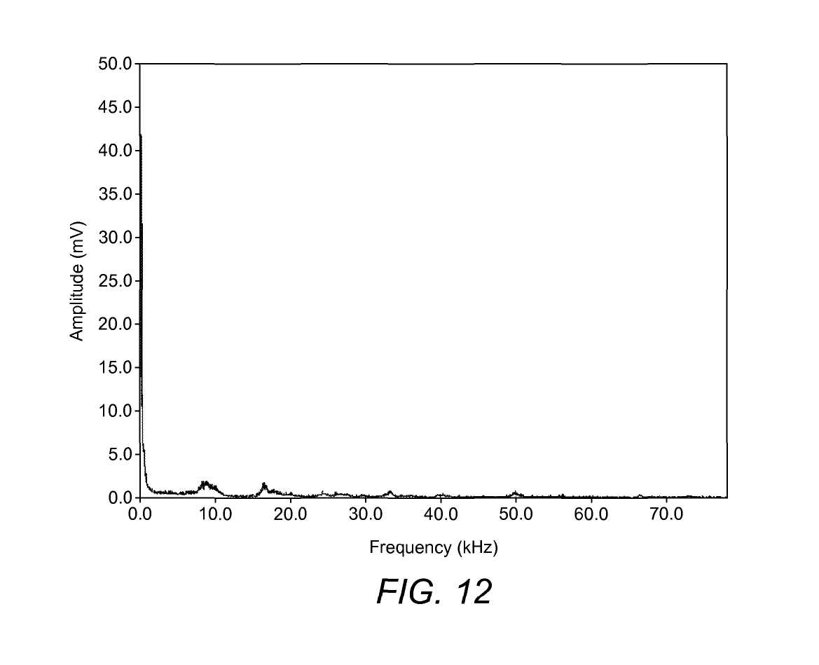

The results of these higher frequency experiments are shown in FIGS. 12 to 17A.

With reference to FIG. 12, vibrations due only to background noise in the laboratory were of low amplitude.

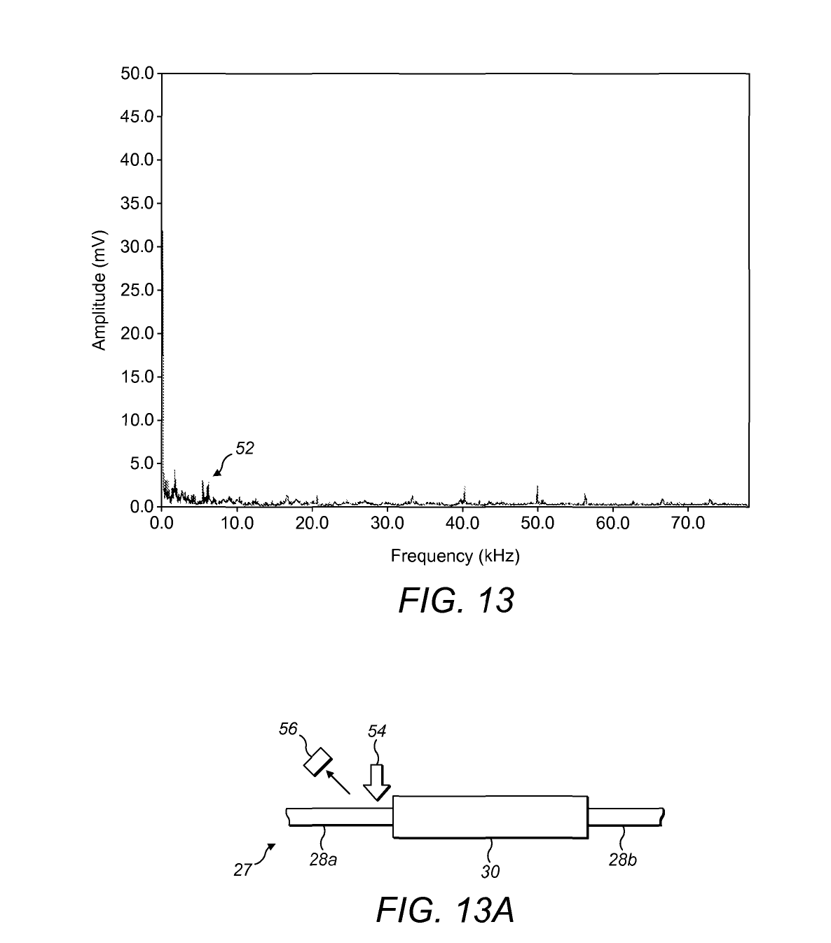

The resonant frequencies 52, 58 and 62 shown in FIGS. 13, 14 and 15 were produced by tapping the assembly 27 with a metal rod as represented by arrows 54, 60 and 64 in FIGS. 13A, 14A and 15A, respectively.

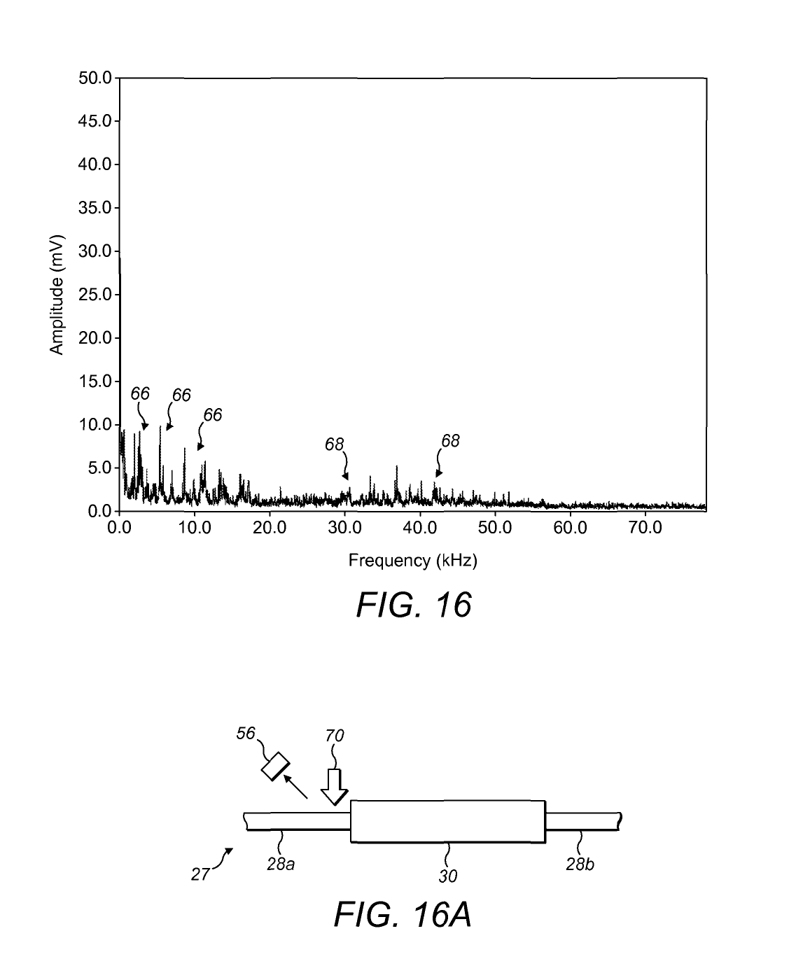

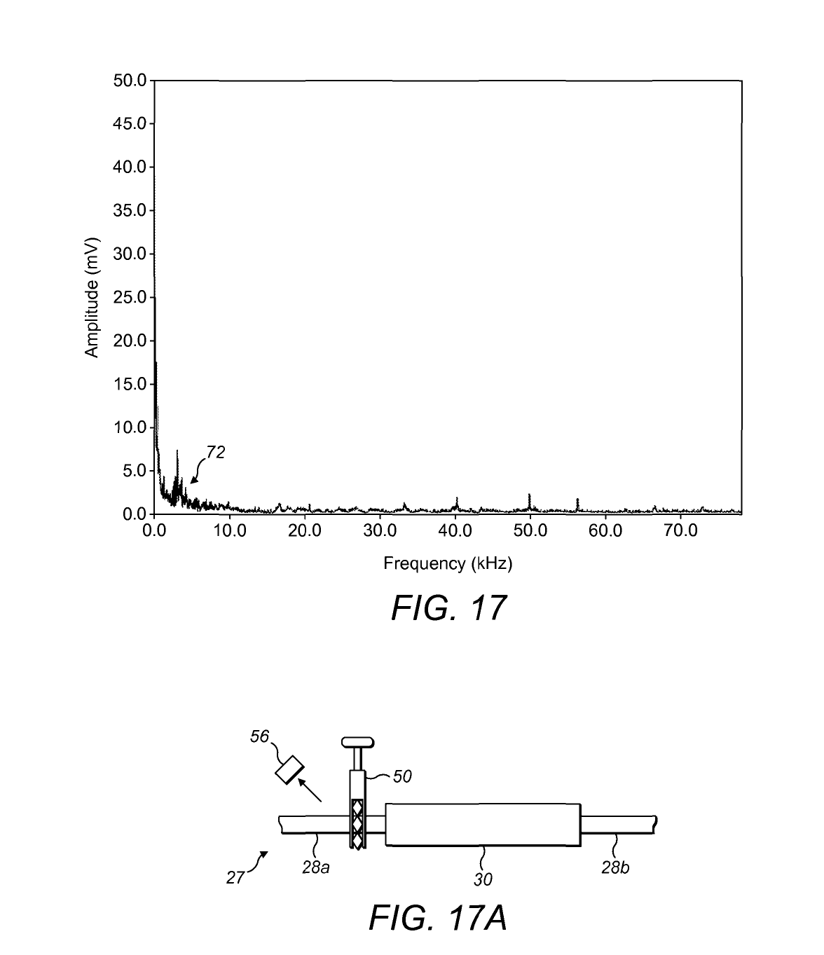

Of particular interest are FIGS. 16 and 17. FIG. 16 shows the response 66 of the assembly 27 when the first section of pipe 28a is being cut with a hacksaw, as represented by arrow 70 in FIG. 16A. FIG. 17 shows the response 72 of the assembly 27 when the first section of pipe 28a is being cut using the manual pipe cutter 50, as shown in FIG. 17A. Some ultrasonic frequencies 68 were detected as shown in FIG. 16. However, it can clearly be seen from FIGS. 12, 13, 14, 15 and 16 that frequency amplitudes of vibrational responses of the assembly 27 in the ultra-sonic region are generally very low or non-existent.

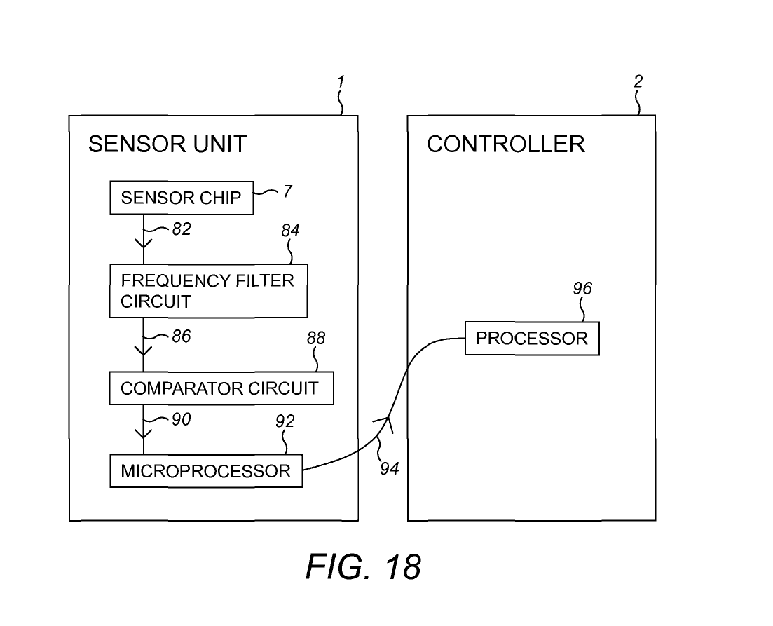

Referring to FIG. 18, the present invention comprises a processing arrangement distributed between a sensor unit 1 and a controller 2, the sensor unit 1 and controller 2 being communicationally linked by a cable 94 comprising three wires. The wires are housed in an overall metal mesh ‘screen’ (for electromagnetic compatibility reasons) and with a further overall outer plastic shroud. This ensures that the cable system is physically durable.

Within the housing 6 the sensor unit 1 includes a sensor chip 7 comprising an accelerometer 15 (FIG. 3) which can operate in any orientation without loss of performance and detects vibrations in three spatial dimensions, X, Y and Z. The sensor chip 7 is entirely solid state and is encapsulated to prevent water ingress without any degradation in performance. The sensor chip 7 is arranged to generate an output 82 associated with the detected vibrations and to communicate this output 82 to a frequency filter circuit 84. The frequency filter circuit 84 filters out frequencies corresponding to vibrations outside the range 100 Hz to 1,500 Hz and communicates a filtered output 86 to a comparator circuit 88. The comparator circuit 88 removes signals representing vibrations having an amplitude below a predefined minimum and generates a resulting output 90. Thus only frequencies in the ‘target’ band of 100 Hz to 1,500 Hz and of sufficient amplitude to be considered as a potential threat are communicated to the microprocessor 92.

The output 90 is communicated to the microprocessor 92 where the majority of processing in the sensor unit 1 takes place. The microprocessor 92 analyses the output 90 to determine whether it indicates a sufficient threat to alert the controller 2. The processing here includes analysing the nature of the vibrations, analysing whether they relate to the signature of a particular mode of attack (such as vibrations associated with a cutting implement such as a hacksaw, electric saw, grinder, pipe cutter etc acting on the exhaust pipe, or a vibration in the exhaust system caused by such implements), and determining the duration of the threat since it was first detected. Thus a short pulse of frequencies which are both in the target frequency band and of sufficient amplitude may nevertheless be found to be too short in duration by the microprocessor to have been generated by cutting tools associated with a potential theft threat. The processing activities of the sensor unit 1 are designed specifically to detect and assess threats whilst constantly rejecting any false alarms. The result of the analysis is to determine a threat level and communicate this to the controller 2.

The microprocessor 92 also constantly generates a ‘heartbeat’ signal which is a series of regular pulses and transmits this through each of the three wires of the cable 94. The heartbeat signal is used to communicate the threat level by interrupting the regular pulses to communicate a potential threat. Various levels of interruption are used to communicate a range of threat levels. A complete lack of the heartbeat signal in any one of the three wires of the cable indicates that one of the wires has been cut and is associated with a maximum threat level and immediate triggering of an alarm event.

An advantage of the heartbeat system of communication is that if any wire or wires are cut, or if any wires are short circuited (for example if a needle is pushed through the insulating layers of the wires) then the heartbeat will cease and the controller 2 will sound the alarm or trigger another alarm event. Thus the sensor unit 1 is inherently protected from tampering.

Upon detection of a vibration which is in the target frequency band, of sufficient amplitude and sufficient duration then the microprocessor 92 in the sensor unit 1 will stop one or several heartbeats depending on its assessment of the threat level. For example, the typical stroke of a hacksaw is in the order of half a second. When the microprocessor 92 detects a threat of this duration it will communicate this to the controller 2 by removing a predetermined number of heartbeats. This will have the effect of significantly increasing the controller's alert level. Thus, a few intense threats will trigger the alarm whereas many milder, shorter lower level threats might not.

The controller 2 is securely mounted under the bonnet and monitors the incoming heartbeat signal, evaluating the alert status if any heartbeats are missed. Having received the threat level from the microprocessor 92, the processor 96 determines whether an alarm event should be generated and if so what the event should be. If it is determined that an alarm event should be generated, the processor 96 initiates this event by sending instructing signals to a siren 3a, beacon 3b (as shown in FIG. 1) or communications module. To prevent false alarms, the controller 2 uses a sophisticated software algorithm to trigger an alarm event only after multiple interruptions to the heartbeat.

The controller 2 also monitors the vehicle battery voltage and triggers an alarm event using its own rechargeable backup battery if the supply from the main vehicle battery is cut. By virtue of this arrangement the system also protects against battery theft.

The system is only armed and active when the vehicle ignition is off. The system can be disabled to allow routine servicing and maintenance of the vehicle.

The present invention provides a robust and reliable detector of attempted theft of a catalytic converter, diesel particulate filter or other exhaust component. Its physical housing and cables are robust, practical and easy to install. The invention may be used independently or may be used as part of existing vehicle protection systems in order to provide enhanced protection whilst preventing false alarms. Embodiments of the invention can be adapted to suit specific frequency bands, specific amplitudes of interest and specific durations of vibrations. Thus, the invention may be readily adapted for use in various protection systems such as fuel tank protection (fuel theft), vehicle load protection (detecting attempted forced entry through the vehicle's doors), and vehicle wheel protection (protecting valuable alloy wheels by sensing vibrations on the wheel axle when the vehicle is stationary).

Many modifications may be made to the specific embodiment described above without departing from the scope of the present invention as defined in the accompanying claims.

1. An anti-theft system for protecting a vehicle exhaust component, the system comprising:
a sensor configured to monitor vibrations associated with a vehicle exhaust system; and
a controller arranged to monitor a signal from the sensor;
wherein the controller is configured to generate an alarm event if the signal from the sensor includes characteristics indicative of vibrations associated with an attempted theft of the vehicle exhaust component.

2. A system according to claim 1, wherein the component is a catalytic converter or a particulate filter.

3. A system according to claim 1, wherein the sensor is coupled to an exhaust pipe of the vehicle.

4. (canceled)

5. (canceled)

6. A system according to claim 1, wherein the vibrations include both mechanical vibrations and sound waves.

7. A system according to claim 1, wherein the system is configured to ignore any vibrations that are associated with normal operation of the vehicle exhaust system.

8. A system according to claim 1, wherein the signal is a heartbeat signal comprising a regular pulsed signal.

9. A system according to claim 8, further adapted to use an uninterrupted heartbeat signal to communicate that no attempted theft has been detected.

10. A system according to claim 8, further adapted to use an interrupted heartbeat signal to communicate that a potential attempted theft has been detected.

11. A system according to claim 10, wherein the system is configured to generate an alarm event if the interrupted heartbeat signal persists for a predetermined time period.

12. (canceled)

13. A system according to claim 1, wherein the sensor is arranged to detect vibrations within a predetermined frequency range.

14. A system according to claim 13, wherein the system is configured to ignore vibrations having frequencies outside the predetermined frequency range.

15. A system according to claim 13, wherein the predetermined frequency range is between approximately 100 Hz and approximately 1,500 Hz.

16. (canceled)

17. A system according to claim 1, wherein the sensor is arranged to detect vibrations in three spatial dimensions.

18. A system according to claim 1, wherein the sensor is further adapted to ignore vibrations having an amplitude below a predefined minimum amplitude.

19. A system according to claim 1, further adapted to generate the alarm event if the characteristics indicative of vibrations associated with an attempted theft persist for a predetermined time period.

20. (canceled)

21. A system according to claim 1, wherein the system is further configured to protect the fuel system of the vehicle.

22. (canceled)

23. (canceled)

24. A system as claimed in claim 1, further comprising a wheel sensor for monitoring vibrations associated with a wheel of the vehicle, the controller being configured to monitor signals from the wheel sensor, and the system being configured to generate an alarm event if the signal from the wheel sensor includes characteristics indicative of vibrations associated with an attempted theft of the wheel.

25. (canceled)

26. A sensor unit for protecting a vehicle exhaust component, the sensor unit comprising:
a sensor as defined in any preceding claim configured to monitor vibrations; and
a housing for the sensor;
wherein the sensor is located within the housing and the housing is arranged to be removably mountable on a vehicle exhaust pipe.

27. A sensor unit according to claim 26, further comprising a bracket for mounting the housing on a vehicle exhaust pipe.
wherein the bracket is arranged to mount the housing such that the housing is spaced apart from the vehicle exhaust pipe.

28-32. (canceled)

33. A method of detecting the attempted theft of a vehicle exhaust component, the method comprising:
monitoring vibrations associated with a vehicle exhaust system; and
generating an alarm event if the vibrations are characteristic of an attempted theft of the vehicle exhaust component.

34-36. (canceled)
